(19) United States
(12) Patent Application Publication
(10) Pub. No.: US 2022/0188656 A1
(43) Pub. Date: Jun. 16, 2022

(54) A COMPUTER CONTROLLED METHOD OF OPERATING A TRAINING TOOL FOR CLASSIFYING ANNOTATED EVENTS IN CONTENT OF DATA STREAM

(71) Applicant: TELETRAX B.V., EINDHOVEN (NL)

(72) Inventors: Gerrit Cornelis LANGELAAR, EINDHOVEN (NL); John Pierre Jacobus VERHAGEN, EINDHOVEN (NL)

(21) Appl. No.: 17/442,931

(22) PCT Filed: Mar. 26, 2020
(86) PCT No.: PCT/NL2020/050207

§ 371 Date: Sep. 24, 2021

(30) Foreign Application Priority Data
Mar. 26, 2019 (NL) 2022812

(51) Int. Cl. G06N 5/02

(52) U.S. Cl. CPC G06N 5/022

(57) ABSTRACT

Accurate real time automatic detection of events in content of a data stream, such as a transition to a commercial block in the content of a broadcast audio/video data stream, relies on a trainable event classifier that operates on a well-balanced training set input to the classifier. The present disclosure provides a computer controlled method of operating a training tool for classifying events annotated in the content of a data stream. The training tool presents training samples comprising separators and corresponding descriptors that relate to trigger features obtained from variations in parameters of the annotated data stream, and derived features restoring relationships between various separators and corresponding descriptors.

### TECHNICAL FIELD

The present disclosure generally relates to data stream processing and, in particular, to a computer controlled method of operating a training tool for classifying annotated events in content of a data stream, and a training tool arranged for operating the method.

### BACKGROUND

Audio and video data streams, broadcasted by radio and TV networks or other media of communication, such as internet streaming, for example, over time, may include various content such as news, movies, and sports reports, with various advertising commercials arranged in-between the content.

Different users and user groups of different age, for example, may adopt different attitudes in handling commercial or other breaks in the content of a data stream. A user, watching a video or listening to audio content, may prefer to receive personalized advertising content, directed to his or hers personal interest or needs, for example. Providing personalized advertising content may help to avoid that a commercial is ignored or even perceived as annoying by a particular user which is, of course, not in the interest of the product or service that is advertised.

For advertisement companies, for example, to deploy a real-time multi-media advertising strategy or for other professional purposes, it may be desirable to real-time identify commercials in-between other content of a data stream.

Besides video and audio content data streams, in a stream of measurement data, such as medical body data relating to blood pressure, heart rate, body temperature, oxygen saturation, and the like, it may be required to detect events projecting or pointing to a particular medical status or condition of a patient in real-time. When monitoring a patient, real-time recognizing or detecting such events may be of vital importance for the patient, as an early warning for medical events and/or for applying an adequate medical treatment, for example.

In geographical data, when moving across a particular area, for example, real-time transitions in positions of objects in a particular geographical area, as well as transitions in the shape, dimensions, type, etc. of the objects in that area and other events need to be observed for avoiding collisions, for example.

In practice, for real-time commercial block detection in audio and video data streams, for example, all advertisements are constantly tagged and stored in a database. Fingerprints of these advertisements are compared against broadcast material in real-time. If a match is found, an advertisement or commercial block is detected and signaled. Keeping such an advertisement database up to date is very time consuming and expensive, in particular because the number of broadcast channels to be monitored can become very large, such as over thousand or more, especially when multiple countries are to be covered.

Alternatives for commercial block detection make use of fully automated machine learning detection algorithms or classifiers. These algorithms are trained to recognize specific characteristics of commercial blocks, such as particular audio and video segments, and try to detect the commercial blocks based on such characteristics. These approaches generally involve a judicious selection of audio and visual segments. The performance of such algorithms or classifiers is, to a large extent, dependent on training samples and is not targeted at real-time usage.

Besides that a lot of effort is required for training an algorithm with features positively indicating a commercial block, even more effort is required in selecting training samples for training the algorithm as to recognize features non-indicative for commercial blocks.

Accordingly, there is a need for real-time automatic detection of transitions in the content of a data stream at which a commercial block or another content break is projected.

More in general, there is a need for a method of generating a training set including positive and negative training samples, for training an event classifier in a detector for real-time detecting events in the content of a data stream, as well as a training tool arranged for operating the method.

### SUMMARY

The above mentioned and other objects are achieved, in a first aspect of the present disclosure, by a computer controlled method of operating a training tool for classifying annotated events in content of a data stream, the data stream comprising a plurality of parameters, the method comprising the steps of:

detecting, by the computer, trigger features from variations in parameters of the data stream;

identifying, by the computer, associated trigger features as separators;

determining, by the computer, descriptors identifying parameter values corresponding to the separators, and

outputting, by the computer, the separators and corresponding descriptors as training samples, positively or negatively indicative of annotated events depending on positions of the separators in the data stream, wherein a number of the separators is determined, by the computer, for obtaining a balanced set of positive and negative training samples.

Instead of detecting matching fingerprints, logos, video and/or audio segments in a data stream, the solution according to the present disclosure is based on the insight that a particular event in the content of a data stream may be represented by one or more separators identified in the data stream, based on a number of associated trigger features detected from parameter variations occurring in real-time in the data stream, and one or more descriptors identifying values of parameters of the data stream corresponding to the separators.

The trigger features may refer to a plurality variations in a plurality of parameters of the data stream. As an example, a transition in the content of a audio and/or video data stream marking the start of a projected commercial block may involve variations in one or more of the parameters of the data stream, such as the audio signal level, brightness and contrast level of image frames of the video stream, text strings embedded in the video frames, and so on. Hence, variations in these parameters may be indicative for a projected commercial block in the content of a data stream.

Trigger features within boundaries of an annotated event, may be identified as separators indicative of the annotated event, or in short as positive training samples. Trigger features detected outside the boundaries may be identified as separators non-indicative of an annotated event, or in short negative training samples. In this manner, the computer controlled method of the present disclosure generates a balanced set of numbers of positive and negative training samples, i.e. equal or nearly equal numbers of separators indicative of and separators non-indicative of the annotated events in a supervised data stream for accurately training an event classifier.

In accordance with the present disclosure, the number of training samples input to an event classifier can be limited by a selective representation of the trigger features of the content of the data stream occurring in time or other metrics, such as geographical distance, for example.

The replacement of a relatively large number of different trigger features with a limited number of associated trigger features identified as separators, together with descriptors related to the separators, reduces the number of training samples input to an event classifier to be trained, which enables fast learning of the event classifier with such a reduced number of training samples.

To accurately train an event classifier, besides trigger features that are identified as separators, descriptors are proposed, which are parameter values of the data stream that corresponds to the separators. For example, a descriptor may be brightness of an image at the occurrence of or in the neighborhood of trigger features identified as a separator. By using descriptors, a trained event classifier can immediately react upon an upcoming event, such as a transition from one type of content to another.

User interaction required with the method of the present disclosure is limited in the sense that events to be detected are to be annotated once by a user in a particular data stream, providing an annotated or supervised data stream for use by the training tool. In the case of an audio and/or video stream, for example, user interaction is performed by indicating transitions in the content of the data stream at which commercial blocks start and/or end. In practice, there may be twenty start/end times in a five hours long broadcast data stream, such that effort required from a user to indicate such transitions is indeed limited.

In the case of a data stream comprising medical data, such as heart rate, blood pressure, body temperature, blood oxygen saturation, etc. over time, the annotated events may be limited to those that point to a physical condition of a patient that forms a dangerous, for example life threatening, medical event.

In accordance with a further embodiment of the present disclosure, the trigger features are defined by qualifying variations in the parameters of the data stream.

For example, by setting different thresholds relating to parameter variations, the qualification and number of detected trigger features can be effectively adapted, such that some thereof may qualify for being be used as separators positively indicative for an event to be detected in the data stream and others qualify for being negatively indicative for an event, such to provide a required balanced set of separators.

For becoming a separator, in accordance with an embodiment of the present disclosure, trigger features may associate by various criteria, such as at least one of occurring in a same time window, clustering, i.e. a number of trigger features occurring in a same time window, order of occurrence, and ranking based on parameter variation of the trigger features.

Whether trigger features may or may not qualify as separators can be set by selecting or adapting any or all of the above-mentioned association criteria. As an example, three trigger features occurring in a same time window may be indicative for an event and, accordingly, may be identified as separators. Instead, two of the three trigger features occurring in a same time window may not be indicative for an event, and not be identified as separators, for example. Hence, the number of features to be input to an event classifier is reduced while the classifier can still be trained properly to detect events in a data stream.

As mentioned above, for the successful training of an event classifier, a number of the positive training samples and a number of the negative training samples have to be balanced or substantially equal. In accordance with an embodiment of the present disclosure, a balanced set of positive and negative training samples is determined, by the computer, by selecting separators having a position in the data stream relating to annotated events, i.e. within set position boundaries of an annotated event, as positive training samples, and by selecting a number of separators not relating to annotated events, i.e. not within set position boundaries of an annotated event, and highest ranked based on corresponding parameter variations, essentially equal to the number of selected separators, as negative training samples.

The term ‘essentially equal’ in connection with the number of positive and negative training samples is to be construed as selecting equal or nearly equal numbers of positive and negative training samples, thereby obtaining a set of positive and negative training sampled balanced as to their numbers.

In the event that the number of positive training samples is too high while a sufficient number of negative training samples is generated, the positive training samples, i.e. the respective separators, may be sorted based on one or more of the association criteria, and then only top-ranked positive training samples may be selected as positive training samples to be input to the event classifier, for example.

In accordance with an embodiment of the present disclosure, the trigger features may be determined or selected in support of obtaining such a balanced set of positive and negative training samples.

That is, a threshold used to qualify variations in parameters defined as trigger features may be adjusted and/or criteria used to associated the detected trigger features to be identified as separators may be adjusted, such as the length of a time window in which trigger features occur, to ensure that a balanced set of positive and negative training samples will be generated.

In accordance with an embodiment of the present disclosure, the identified separators are further processed, by the computer, to obtain derived features and these derived features are outputted as part of the training samples. The term ‘derived features’ refers to characteristics of the identified separators in relation to the annotated events in the annotated data stream.

A derived feature may comprise, for example, the mutual occurrence of separators in the data stream, such as the occurrence of particular number of separators in a certain time period from a respective identified separator. Accordingly, derived features may be part of the training samples and used to verify whether separators identified as being positively indicative of an event in a data stream are genuine separators, for example. This may advantageously differentiate between real and false positives and thereby ensures even better accuracy of the event classifier.

In particular, by the derived features it is possible to store the separators and corresponding descriptors as training samples independent of their position or time-relation in a respective data stream. A time relationship between various training samples is then provided or restored by the derived features.

Prior to outputting the training samples for training an event classifier in a detector, according to the present disclosure, the separators and descriptors may be normalised. This may involve determining a respective threshold for a selected trigger feature, such as signal power drop, and normalising values between 0 and 1 and coding speech/music/mixed labels as 1 −1 −1/−1 1 −1/−1 −1 1, for example. Normalisation allows the event classifier to process the input training samples in a uniform manner.

In a particular embodiment of the present disclosure, an event is a projected transition in the content of a data stream, such as a start of a data block in a data broadcast stream, in particular a start of a commercial in a video or audio broadcast stream.

Identifying the start of a commercial block may already contain sufficient information to act upon in practice. For example, to insert or replace a projected general commercial block in a broadcast data stream by dedicated or personalized commercial information, or to start a multi-media campaign by professional users, for example.

Following the identification of the start of a data block in a data stream, an end of that data block may be determined conveniently, by the computer, based on a classification of a length of the data block and at least one of the detected trigger features and derived features of the data stream.

Depending on the length of commercial blocks, for example, same may be generally classified as long, medium or short blocks. Based on this classification and by observing parameters of the data stream, such as some continuous audio and video parameters, for example speech/music classification, shot rate, etc., the end of the commercial block may be conveniently determined. Of course, this part may be omitted if accuracy for the end time of an event is not or less important.

The method according to the present disclosure is applicable to a variety of data streams, and each type of data stream will result in a particular set of training samples representative for a particular type of data stream and/or particular events in a data stream.

In the case of a data stream comprising at least one of video content and audio content, examples of trigger features in the video content comprise at least one of a video scene change, a letterbox change, a black video frame, a monochrome video frame, video signal fading-in and video signal fading-out, and examples of trigger features indicative of a projected transition in the audio content comprise at least one of an audio signal power drop, speech-to-music change, music-to-speech change, mixed speech and music change, audio signal fading-in and audio-signal fading out, and mono-ness.

In the case of a data stream comprising at least one of environmental content and measured content, examples of trigger features in the environmental content comprise at least one of a geographically moving object, a geographical change in object shape, a geographical change in object type, and examples of trigger features indicative of an event in the measured content comprise at least one of a body temperature change, a pressure change, a luminance change, a chemical composition change, an olfactory change and an acoustic change.

In the case of a data stream comprising measured medical data over time, examples of trigger features may comprise changes in parameters such a heart rate, blood pressure, body temperature, blood oxygen saturation, etc. The annotated events may be limited to those that point to a physical condition of a patient that forms a dangerous, for example life threatening, medical event.

In accordance with an embodiment of the present disclosure, the derived features are determined, by the computer, from at least one of:

audio or video classification value of the data stream based on a time period prior to a separator;

time length value of an audio or video signal level transition;

actual time difference value between an audio signal level transition and a video signal level transition;

number of previous separators during a set time interval prior to a separator, and

actual time length value between separators in a set time interval.

Derived features in the form of any of the above features or relation between the same may be used for quick detection or verification of events in a data stream.

In a second aspect of the present disclosure there is provided a computer controlled training tool for classifying annotated events in content of a data stream, the data stream comprising a plurality of parameters, the computer arranged for performing the steps of:

detecting trigger features from variations in parameters of the data stream;

identifying associated trigger features as separators;

determining descriptors identifying parameter values corresponding to the separators, and

outputting the separators and corresponding descriptors as training samples, positively or negatively indicative of annotated events depending on positions of the separators in the annotated data stream, wherein a number of the separators is determined for obtaining a balanced set of positive and negative training samples. The computer may be arranged for performing further steps of the above disclosed method according to the present disclosure.

In an embodiment the computer comprises a support vector machine or a convolutional neural network, and a converter machine for translating identified separators into an event presence probability in the data stream.

A third aspect of the present disclosure provides a computer readable storage medium, storing computer program code instructions which, when loaded onto one or more computers, causes the one or more computers to perform the method in accordance with the first aspect of the present disclosure.

In a fourth aspect the present disclosure provides a computer readable storage medium, comprising a set of training samples obtained in accordance with the first aspect of the present disclosure.

A fifth aspect of the present disclosure provides a classifier, comprising a computer, arranged for operating with a set of training samples in accordance with the fourth aspect of the present disclosure.

The above-mentioned and other aspects of the present disclosure will be further elucidated with reference to non-limiting example embodiments described hereinafter.

### BRIEF DESCRIPTION OF THE DRAWINGS

FIG. 1 illustrates, in a flow chart type diagram, an example of detailed steps of a computer controlled method of operating a training tool for detecting annotated events in content of a data stream, in accordance with the present disclosure.

FIG. 2 illustrates, schematically, part of an audio and video data stream with annotated events processed in accordance with the method of FIG. 1, including trigger features, separators and derived features provided as training samples, in accordance with the present disclosure.

FIG. 3 illustrates, schematically, an example of derived features from identified separators in the annotated data stream of FIG. 2, in accordance with the present disclosure.

FIG. 4 illustrates, schematically, an alternative example of trigger features based on geographical content data in accordance with the present disclosure

FIG. 5 illustrates, schematically, a training tool for classifying annotated events in content of an annotated data stream in accordance with the present disclosure.

### DETAILED DESCRIPTION

In the following description and claims of the present disclosure, the following terms are used.

The term real-time refers to the processing or the execution of data in a short time period after collecting same, providing near-instantaneous output. Real-time data processing is also called stream processing, because of the continuous stream of input data required to timely yield output for the purpose of a process that is momentarily carried out. This, in contrast to a batch data processing system, that collects data and then processes all the data in bulk at a later point in time, such that the processing result will become available only after all the data have been collected.

The term parameter refers to characteristics that may be used to define or characterize a data stream. For an audio and video data stream, the parameters may be, for example, volume of an audio signal, brightness of a video frame, color of an image, and so on. For a geographical data stream, the parameters may be, for example, presence of buildings, trees, moving objects and so on. For a stream of medical data parameters may comprise heart rate, blood pressure, body temperature, blood oxygen saturation, etc.

The term ‘trigger features’ refers to variations in parameters of the data stream.

The term ‘separator’ refers to associated trigger features.

The term ‘descriptors’ refers to parameter values corresponding to separators that are identified.

The term ‘derived features’ refers to results obtained from further processing of the separators.

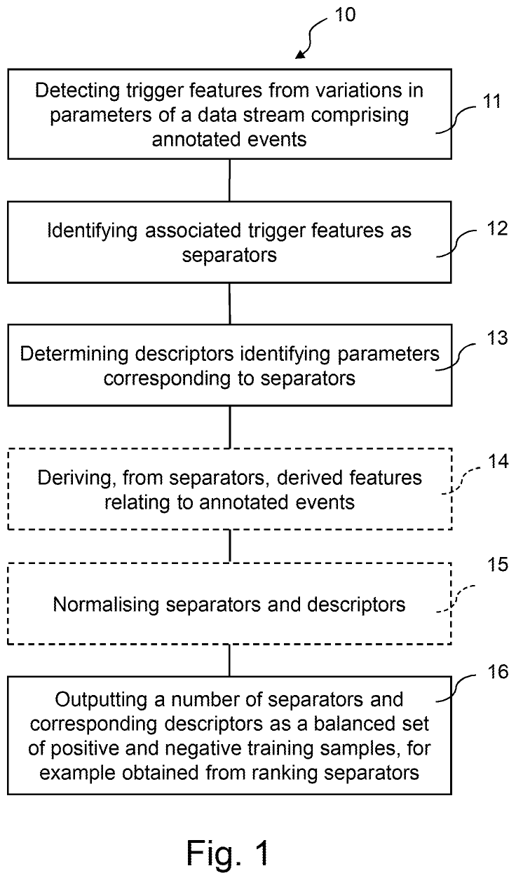

FIG. 1 illustrates, in a flow chart type diagram, an example of detailed steps of a computer controlled method 10 of operating a training tool for providing a training set for training an event classifier in a detector for detecting events in the content of a data stream, in accordance with the present disclosure.

The method 10 will be elucidated with reference to the detection of events or transitions marking commercial or advertising blocks or breaks in the content of an audio and video broadcast data stream comprising, among others, movies, news and sport items, as well as commercial blocks, for example. Such transitions in the content pointing to a commercial block are referred to as projected transitions, as they are planned beforehand.

The method 10 operates on a data stream in which starts and/or ends of commercial blocks are annotated, for example by a user that has viewed the data stream beforehand and provided the annotations, or from information provided by a broadcast organisation or a content provider, for example. For the purpose of the present disclosure, the annotations may be provided as a particular point in time at which a commercial block or break starts and/or stops, measured with respect to a reference point in time. Such an annotated data stream is also referred to as a supervised data stream.

The method starts with step 11, in which a computer detects trigger features from variations in parameters of the supervised data stream, such detected or identified trigger features may be potentially indicative of an event. In this example, the trigger features may indicate a transition in the content that may point to the start of a commercial block.

Content of the data stream may be represented by various parameters. Trigger features that may be used for detecting an event may relate or correspond to variations in one or more of these parameters.

In the case of an audio and video stream, trigger features potentially indicative of a projected transition pointing to a commercial break may include, for example, at least one of a video scene change, such as a scene change, for example YUV or HSB histogram based, a letterbox change, a black video frame, a monochrome video frame, video signal fading-in and video signal fading-out, an audio signal power drop, speech-to-music change, music-to-speech change, mixed speech and music change, for example in segments of 5 seconds, audio signal fading-in and audio-signal fading out, and mono-ness represented by a ratio of audio energy between left and right channels (R+L)/(R-L), for example.

As not all detected trigger features indeed correspond to a genuine event or transition in the data stream, the method 10 then proceeds to step 12 where the computer identifies associated trigger features as separators. Association of the trigger features may also be referred to as trigger feature packing.

The identified separators may consist of a group of trigger features that are associated in accordance with a number of different criteria. As an example, if a time difference between a centre of an audio signal power drop, identified by a first trigger feature and a video cut in a data stream, identified by a second trigger feature, is smaller than a predefined threshold TD, a separator may be identified. Further examples of criteria for associating trigger features may include features occurring in a same time window, i.e. clustering, that is the number of trigger features in a particular settable time window, an order of occurrence of trigger features, and ranking based on parameter variation of the trigger features, for example.

It is noted that the identified separators may be positively or negatively indicative of an event in the data stream, depending on positions of the separators in the data stream. A separator that is positioned between annotated transitions in a data stream, such as between start and end of a commercial block, is a separator that may positively indicate an event, that is the commercial block. On the other hand, a separator that falls outside boundaries of such a commercial block does not point to or is negatively indicative of a commercial block.

In accordance with the method 10, the trigger features and separators are determined for obtaining a balanced set of positive and negative training samples. This is realized by a proper qualification of variations in the parameters the data stream that are detected as the trigger features, together with association of the trigger features as the separators.

For example, a threshold used to qualify variations in parameters defined as trigger features may be adjusted such that a certain number of trigger features are detected inside and outside time boundaries of an annotated event may become more or less. In addition to that, criteria used to associate the detected trigger features to be identified as separators may also be adjusted as necessary, such that less or more trigger features may be selected as training samples, and eventually input to an event classifier. Such adjustments may therefore be used to ensure that a balanced set of positive and negative training samples will be generated.

An event classifier trained with both positive and negative separators is capable of detecting events in a data stream more accurately as information on both true and false positives are available to the classifier during its training.

With the identification of separators corresponding to the event, at step 13 the method determines descriptors identifying parameter values of the data stream that corresponds to the separators.

To accurately train an event classifier, besides the trigger features that are identified as the separators, descriptors are introduced, which are parameter values of the data stream that correspond to or are in a certain small neighbourhood of the separators. For example, a descriptor may be the brightness of an image at or around a moment when trigger features identified as a separator are present. By using the descriptors, a trained event classifier can immediately react upon an upcoming event in the content of a data stream, such as a transition from one type of content to another in the time domain.

Optionally, in accordance with the present disclosure, the separators indicative of an event in the supervised data stream may be further processed, at step 14 to obtain derived features, which may be used to confirm that an identified separator indicates a true positive event and to allow the event classifier to be trained even more accurately with the identified separators to detect genuine events.

For the audio and video broadcast data stream used in this embodiment of the present disclosure, the derived features may be determined from at least one of the following trigger features: audio or video classification value of the data stream based on a time period prior to a separator; time length value of an audio or video signal level transition; actual time difference value between an audio signal level transition and a video signal level transition; number of previous separators during a set time interval prior to a separator, and actual time length value between separators in a set time interval.

Prior to outputting the identified separators and descriptors as training samples for training an event classifier, according to the present disclosure, the separators and descriptors may optionally be normalized at step 15. This may involve determining a respective threshold for a selected trigger feature, such as signal level transition, and then values of the trigger feature are normalized to values between 0 and 1. It may also involve coding speech/music/mixed labels as 1 −1 −1/−1 1 −1/−1 −1 1.

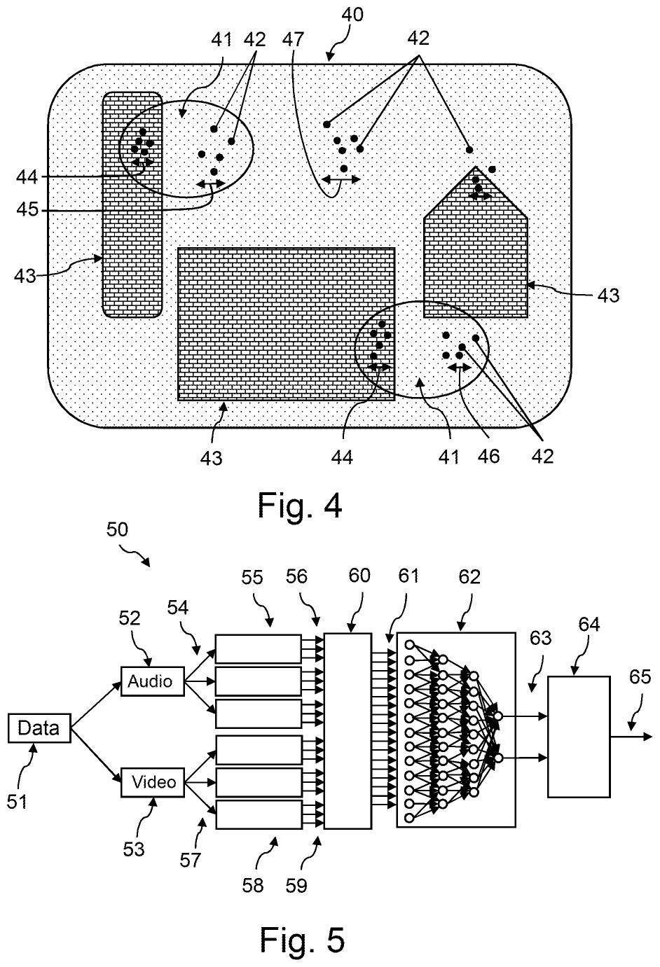

Next, at step 16, both the identified separators and descriptors, possibly normalised, are output by the computer as a balanced set of equal or essentially equal numbers of positive or negative training samples for training an event classifier in a detector for detecting events in content of a data stream. For obtaining such a balanced set of training samples, this step may include one or both of ranking of the separators and/or adjusting and/or setting criteria used to associated the detected trigger features to be identified as separators, for example in a manner as elucidated below with reference to FIG. 4.

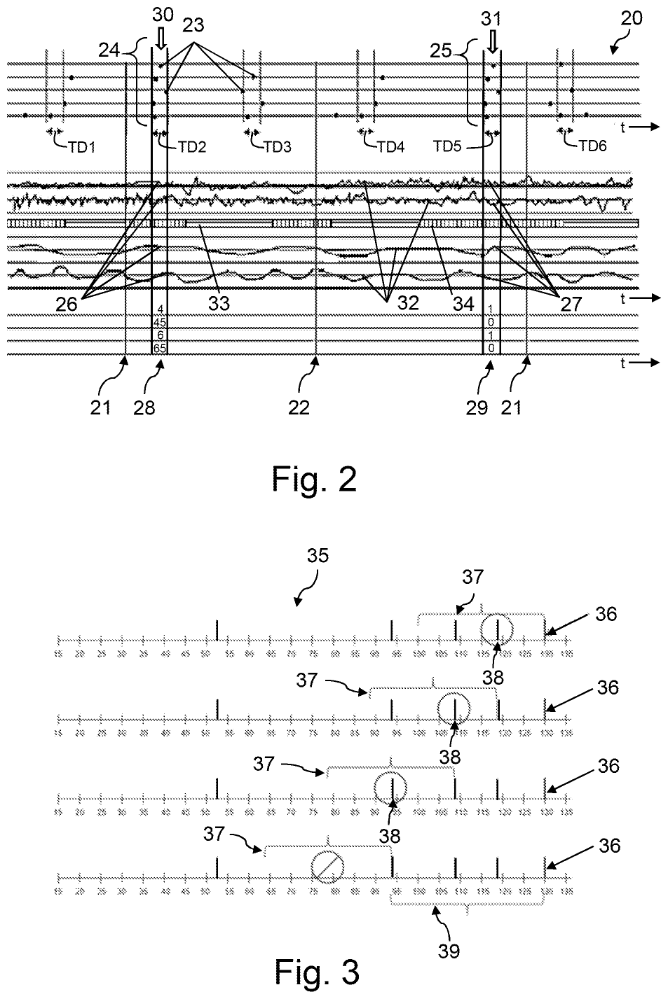

FIG. 2 illustrates, schematically, a supervised data stream 20 processed in accordance with the method of the present disclosure.

In FIG. 2, reference numerals 21 and 22 represent annotated events, i.e. projected transitions, such as a start 21 and an end 22 of a commercial block at a particular point in time t, in the content of the supervised data stream 20.

Continuous curves along horizontal time lines in the middle part of FIG. 2 represent various values of parameters 32 of the data stream 20 in time t, such as brightness of an image, audio signal strength, etc. The block type line in varied shades shown in the middle part of FIG. 2, for example, represents a classification of presence of speech 33 or music 34 or presence or absence of a logo, and so on.

At horizontal time lines in the upper part of FIG. 2 trigger features 23 are indicated, that are specific variations in the parameters 32. Occurrence or presence of a trigger feature at a point in time is depicted as a discrete black dot. Trigger features 23 in the parameters are present when certain criteria with respect to variations or changes in the parameters 32 are met.

Trigger features 23 may be defined, for example, with reference to parameter thresholds, by which variations or changes in the parameters 32 can be qualified. For example, assume that the first line in the upper part of FIG. 2 represents an audio signal drop of the supervised data stream 20 below a defined threshold. A dot at this line represents such audio signal drop in the supervised data stream 20 at a particular point in time t. Assume that the second line of the upper part of FIG. 2 represents a black video frame. A dot at this line may represent the occurrence of a black video frame in the supervised data stream 20 at a particular point in time t, for example, etc. For clarity of the drawing, not all the trigger features in FIG. 2 are referenced by a reference numeral 23.

In accordance with the present disclosure, separators 24 and 25 are identified with reference to an association of different trigger features 23. As an example, if a time difference between a centre of an audio signal power drop and a video cut is smaller than a predefined threshold TD, a separator may be created.

In the example of FIG. 2, the association between a trigger feature 23 on the first horizontal line in the upper part of the figure, i.e. an audio signal power drop, and a trigger feature 23 on the second horizontal line in the upper part of the figure, i.e. a black video frame, may be defined as a time difference or time window TD between occurrence of these two trigger features 23. If the time difference TD between the two trigger features 23 is smaller than a set threshold, such as TD2 or TD5, a separator 24 and 25 is identified, for example.

An association of different trigger features 23 may also be defined as being a cluster of a certain number of trigger features 23 within a time period. In the example of FIG. 2, a separator may also be identified if there are, for example, more than four trigger features 23 within a time difference or time window TD1 to TD6. It is seen that in TD2 and TD5 there occur five trigger features 23, allowing this cluster of these trigger features occurring in TD1 and TD 5 to be identified as separators.

Other associations between trigger features 23 may be defined with reference to the order of occurrence and/or ranking based on parameter variations of the trigger features 23, for example.

After identifying the separators 24, 25, descriptors 26 and 27 are selected, which are parameter values of the data stream 20 that occur at the same time or in a certain neighbourhood of the separators 24 and 25, respectively.

Descriptors 26, 27 may refer to all or just part of values of the parameters 32 corresponding to a separator 24, 25, respectively. As an example, descriptors 26, 27 may include an audio level or brightness level as well as other parameter levels or values of the supervised stream 20 in FIG. 2, in periods identified with the time differences or time windows TD2 and TD5, for example, corresponding to the separators 24 and 25.

The separator 24 occurs between the boundaries of start 21 and end 22 of an annotated commercial block, therefore, the separator 24 is positively indicative of the commercial block. In contrast, the separator 25 is outside the boundaries of the commercial block, therefore, it is negatively indicative of the commercial block.

The separators 24 and 25 and the corresponding descriptors 26, 27 are part of training samples 30 and 31, respectively, for training an event classifier of a detector for detecting events in a data stream.

The lower part of FIG. 2 illustrates so-called derived features 28 and 29, which represent a number of so-called bridge points for the separators 24 and 25. In this example, reference numeral 28 refers to derived features relating to separator 24 and indicates a number of corresponding previous separators, such as four or six bridge points spanning a time window of 45 or 65 seconds, for example. Reference numeral 29 refers to derived features relating to separator 25 and indicates that there are no previous corresponding separators, i.e. the time window is zero seconds.

The derived features are optionally provided as part of the training samples 30, 31 for additionally verifying whether the separators indicative of a transition are genuine separators indicating the start 21 of a commercial block in the content of a data stream 20, for example.

Due to the derived features 28 and 29, it is possible to store the separators and corresponding descriptors 24, 26 and 25, 27 as training samples independent of their position or time-relation in a respective data stream. The time-relation between the various training samples is then provided or restored by the derived features.

FIG. 3 illustrates, schematically, an example of obtaining derived features from identified separators in an annotated audio and video data stream. In FIG. 3, separators are indicated by short vertical lines along the time scale.

As a derived feature, the number of so-called bridge points preceding a separator in time are to be identified in the data stream. In this example, a bridge point is a separator that is within a certain time range, also called a bridge, preceding a respective identified separator. In FIG. 3, by way of example, the derived feature to be calculated is the number of bridge points 38 preceding a current separator 36 in a time window or bridge 37 of t=31 seconds.

First it is determined whether there is a separator within a range of 31 seconds at the left side from the separator 36 that occurs at time t=130 seconds. The answer is affirmative, because there is another separator or bridge point 38 at time t=119 seconds. The bridge 37 is then shifted to the separator point at 119 seconds and the process is repeated, i.e. illustrated at the second line of FIG. 3, until no separator points are found to the left of a current separator within the bridge of 31 seconds. From FIG. 3 it is clear that another two separators or bridge points 38, respectively at 109 seconds and 94 seconds are found. Hence in total three bridge points 38, shown encircled, are identified to precede the separator 36.

If no more separators are present within the bridge length of 31 seconds left of the separator at 94 seconds, it may be derived that, for the separator 31 at 130 second and the bridge 37 of 31 seconds, the number of bridge points equals three, and the total bridging length 39 is 36 seconds (130−94=36 seconds).

Accordingly, in this example, it may be concluded that a separator 36 for a bridge 37 of 31 seconds occurs three times in a total bridging length 39 of 36 seconds. This procedure may be repeated for other lengths of the bridge 37, to obtain further derived features by which the separators and descriptors are related in time.

FIG. 4 illustrates, schematically, an alternative example of derived features based on geographical content data in accordance with the present disclosure. FIG. 4 shows an area 40 comprising different shaped and differently located objects 43.

In the example of FIG. 4, the content of a data stream is not time-dependent but location dependent data across the area 40, i.e. the metric is distance or length and not time. Annotation is performed in advance to marked events, which are indicated by ovals 41, i.e. transition areas between the objects 43. Trigger features that are likely indicative of an event, such as “house present”, “tree(s) present”, “moving object” and the like are identified from the data stream and indicated with dots 42. When the trigger features 42 are associated in accordance with one or a number of settable criteria, for example that the number of trigger features in a respective cluster distance is above a set threshold, it may be decided that these trigger features may be used as separators for training a related classifier, such as separators 44, 45, 46, 47 for example.

The respective objects 43 may serve as descriptors corresponding to the identified separators 44, 45, 46, 47 and/or specific parameters of the data stream that correspond to a separator may be used as descriptors, such as temperature and altitude of a geographical location being processed, for example.

To restore a relation between trigger features 42, derived features may be used. Derived features that may be identified are, for example, a number of trigger features around a temperature of thirty degree about half an hour ago or the occurrence of bridging separators with a certain bridge distance, for example. In a practical example of the present disclosure, a data stream of TV programs recorded over 24 hours is used to generate 1000 positive training samples and 1000 negative training samples. Herein, a time difference TD between a centre of an audio signal power drop and a video cut is used as a criterion for determining whether a trigger feature may be used as a separator for indicating a projected transition between a commercial block and other TV programs or content items.

Based on the above method 10 described with reference to FIG. 1, the recorded audio/video data stream of TV program is first annotated to indicate start and stop times of commercial blocks, i.e. projected transitions between the commercial blocks and other content of the data stream.

Next, all parameters of the annotated data stream are calculated. At this point no feature packing is applied yet.

A threshold based on the signal power drop, which is one of the parameters of the data stream, is adjusted such that there are at least 1000 signal power drop areas inside and outside the annotated transition points, for example. These signal drop areas are the trigger features potentially indicative of a projected transition, that is, the presence of a commercial block in the TV program.

If there are not enough signal power drop areas, the recorded data stream may be extended for a couple of hours.

After obtaining the intended number of signal power drop areas, a threshold is set for the time difference between a centre of an audio signal power drop and a video cut as the criterion to associate trigger features for the purpose of identifying separators.

First, the time difference is set to a value close to zero. Now there are more positive training samples inside the annotated areas than negative ones outside the annotated areas.

The threshold time different is gradually increased, until the desired number of negative training samples is obtained, that is, until there are also about 1000 negative training samples. If the threshold time difference becomes larger than, for example, one second, the signal power drop threshold is adjusted again such that more signal power drop areas are available.

When the desired number of negative training samples is achieved, it is likely that there are too many positive training samples. In this case, the positive training samples are sorted, i.e. ranked, from shortest time difference to longest time difference. And the top 1000 of the shortest time differences are selected as the positive training samples.

Generally, the number of negative training samples will be larger than the number of positive training samples. In that case, the negative training samples are ranked, i.e. the respective separators, based on corresponding, for example similar, parameter variations of the annotated data stream, as elucidated above, while the top number of separators is taken from the ranked list as the number of negative training samples.

As a result, a balanced set of positive and negative training samples, for training an event classifier in a detector for detecting events in content of an audio/video data stream, is thus generated.

FIG. 5 illustrates, schematically, a training tool 50, for qualifying annotated events in content of a supervised data stream. The person skilled in the art will appreciate that respective components of the training tool 50 may be wholly or partly implemented in software, i.e. processor controlled, and or by dedicated hardware components, what ever applicable.

Input to the training tool is an annotated or supervised audio/video data stream 51, for example TV programs, comprising different audio and video content, such as news, movies, and sports reports, with various advertising commercials arranged in-between the content. The start and/or end of a commercial blocks is previously annotated, as described above. A capturing module (not shown). may be arranged for splitting the captured data stream into different components, including for example raw audio data 52 and raw video data 53.

Parameters of the raw audio data 52, schematically indicated by arrows and referred to by reference numeral 54, are input to audio feature extractors 55, providing audio related trigger features 56. Parameters of the raw video data 53, likewise indicated by arrows and referred to by reference numeral 57, are input to video feature extractors 58, providing video related trigger features 59. The feature extractors 56 and 58 detect trigger features from variations in de parameters 54, 57 based on several settable thresholds and other criteria for qualifying an detected variation or change as a trigger feature, as elucidated above.

The thus identified trigger features 56,59 are input to a feature packer 60. The feature packer 60 operates to provide training samples 61 comprising separators, using associations between trigger features according to various settable association criteria, descriptors relating to corresponding parameter values or levels, and derived features, in accordance with the method described above, wherein a number of said trigger features and separators are determined for obtaining a balanced set of positive and negative training samples.

The separators and corresponding descriptors are then input to a trainable event classifier 62. The trainable event classifier 62 may be a support vector machine, SVM, or a convolutional neural network, CNN, for example, among others arranged for providing whether a particular training sample is positively or negatively indicative for a an annotated event, i.e. a commercial block transition in the data stream 51, and the output 63 of the trainable event classifier 62 is then input to a convertor 64 which eventually translates single transition decisions back into a continuous commercial block presence probability 65.

The present disclosure has been described herein with reference to several detailed examples. Those skilled in the art will appreciated that the disclosure is not limited to the disclosed embodiment. It shall also be understood that an embodiment of the present disclosure can also be any combination of the claims and embodiments presented.

1-16. (canceled)

17. A computer controlled method of operating a training tool for classifying annotated events in content of a data stream, the data stream comprising a plurality of parameters, the method comprising the steps of:
detecting, by the computer, trigger features from variations in parameters of the data stream;
identifying, by the computer, associated trigger features as separators;
determining, by the computer, descriptors identifying parameter values corresponding to the separators; and
outputting, by the computer, the separators and corresponding descriptors as training samples, positively or negatively indicative of annotated events depending on positions of the separators in the data stream, wherein a number of the separators is determined, by the computer, for obtaining a balanced set of positive and negative training samples.

18. The method according to claim 17, wherein the trigger features are defined by qualifying variations in the parameters.

19. The method according to claim 17, wherein trigger features are associated by at least one of occurring in a same time distance or window, clustering, order of occurrence, and ranking based on parameter variations of the trigger features.

20. The method according to claim 17, wherein a balanced set of positive and negative training samples is determined by selecting separators having a position in the data stream relating to annotated events as positive training samples, and by selecting a number of separators not relating to annotated events and highest ranked based on corresponding parameter variations, essentially equal to the number of selected separators, as negative training samples.

21. The method according to claim 17, further comprising the steps of:
deriving, by the computer, from the separators, derived features relating to the annotated events; and
outputting, by the computer, the derived features as part of the training samples.

22. The method according to claim 17, further comprising normalizing the separators and descriptors prior to outputting the training samples.

23. The method according to claim 17, wherein an event is a projected transition in content of a data stream, wherein the projected transition is a start of a data block in a data broadcast stream.

24. The method according to claim 23, wherein the start of a data block in a broadcast data stream is the start of a commercial in a video or audio broadcast stream.

25. The method according to claim 23, wherein the data stream comprises at least one of video content and audio content, wherein trigger features indicative of a projected transition in the video content comprise at least one of a video scene change, a letterbox change, a black video frame, a monochrome video frame, video signal fading-in and video signal fading-out, and wherein trigger features indicative of a projected transition in the audio content comprise at least one of an audio signal power drop, speech-to-music change, music-to-speech change, mixed speech and music change, audio signal fading-in and audio-signal fading out, and mono-ness.

26. The method according to claim 17, wherein the data stream comprises at least one of environmental content and measured content, wherein trigger features indicative of an event in the environmental content comprise at least one of a geographically moving object, a geographical change in object shape, a geographical change in object type, and wherein trigger features indicative of an event in the measured content comprise at least one of a temperature change, a pressure change, a luminance change, a chemical composition change, an olfactory change and an acoustic change.

27. The method according to claim 23, wherein the derived features are determined, by the computer, from at least one of:
audio or video classification value of the data stream based on a time period prior to a separator;
time length value of an audio or video signal level transition;
actual time difference value between an audio signal level transition and a video signal level transition;
number of previous separators during a set time interval prior to a separator; and
actual time length value between separators in a set time interval.

28. The method according to claim 17, wherein the steps of the method are implemented as computer program instructions stored on a computer readable storage medium loadable onto one or more computers.

29. The method according to claim 17, wherein the steps of the method are implemented as a set of training samples of a computer readable storage medium.

30. The method according to claim 29, wherein the set of training samples are operated by a classifier, comprising a computer.

31. A computer controlled training tool for classifying annotated events in content of a data stream, the data stream comprising a plurality of parameters, the computer configured to perform the steps of:
detecting trigger features from variations in parameters of the data stream;
identifying associated trigger features as separators;
determining descriptors identifying parameter values corresponding to the separators; and
outputting the separators and corresponding descriptors as training samples, positively or negatively indicative of annotated events depending on positions of the separators in the data stream, wherein a number of the separators is determined for obtaining a balanced set of positive and negative training samples.

32. The computer controlled training tool according to claim 31, wherein the computer comprises at least one of a support vector machine and a convolutional neural network, and a converter machine for translating identified separators into an event presence probability in the data stream.
